(19) United States
(12) Patent Application Publication
(10) Pub. No.: US 2025/0023170 A1
(43) Pub. Date: Jan. 16, 2025

(54) BATTERY CASE AND BATTERY PACK

(71) Applicants: BASF SE, Ludwigshafen Am Rhein (DE); BASF (CHINA) COMPANY LIMITED, Shanghai,Shanghai (CN)

(72) Inventors: Guo Dong FU, Shanghai (CN); Xin Gang WANG, Shanghai (CN); Zhan GAO, Shanghai (CN); Shuai Ping GONG, Shanghai (CN)

(21) Appl. No.: 18/713,349

(22) PCT Filed: Dec. 21, 2022
(86) PCT No.: PCT/EP22/87159

§ 371 Date: May 24, 2024

(30) Foreign Application Priority Data
Dec. 31, 2021 (CN) 202111677998.5
Dec. 31, 2021 (CN) 202123429243.1

(51) Int. Cl. H01M 50/24; B60L 50/64; H01M 50/227; H01M 50/231; H01M 50/271

(52) U.S. Cl. CPC H01M 50/24; B60L 50/64; H01M 50/227; H01M 50/231; H01M 50/271; H01M 2220/20

(57) ABSTRACT

Disclosed herein is a battery case, which includes at least one resin-based composite material layer and at least one waterproof layer, where the resin-based composite material layer and the waterproof layer are bonded to each other by hot pressing. In addition, disclosed herein is a battery pack, which includes the battery case.

### TECHNICAL FIELD

The present invention relates to the field of new energy vehicle batteries. More specifically, the present invention relates to battery cases for new energy vehicle batteries, and battery packs comprising the battery cases.

### BACKGROUND ART

The battery cases for new energy vehicles in the art mainly adopt the combination of an aluminum alloy tray and a battery cover formed by injection molding of engineering plastics, resulting in large battery weight and high power consumption. Therefore, weight lightening of new energy vehicle batteries has always been one of the main focuses and difficulties of modern vehicle technology. In addition, although the existing batteries of new energy vehicles all have a completely enclosed structure, the waterproof effect is still unsatisfactory; thus, when immersed in water, those batteries pose a great potential safety hazard. Especially, in recent years, the country has frequently experienced heavy rain which led to flooding or waterlogging, and it happens on ossasion that new energy vehicles are immersed in water, especially in rain water. As rain water has stronger conductivity, once the battery leaks, it poses non-negligible safety problems.

CN 209786038U discloses a vehicle battery with a good waterproof effect, which comprises a battery body and a battery case, wherein a first waterproof layer is adhered to the inner wall of the battery case, and a second waterproof layer is adhered to the surface of the battery body, and a water absorption layer is filled between the first waterproof layer and the second waterproof layer. Although the invention achieves good waterproof performance through combination of multiple layers of waterproof and water absorption materials, it has a relatively complicated structure and the productivity is low and the large-scale continuous production is difficult.

CN212810424U discloses a waterproof and explosion-proof ternary lithium battery, which comprises a battery pack, an insulation protection plate, a waterproof film and a case, wherein the insulation protection plate and the waterproof film are sequentially wrapped around the outer side of the battery pack and are located in the case, and a waterproof adhesive is applied to the outer sides of the two ends of the waterproof film, and a silicone layer is filled between the waterproof film and the case. The invention also has the problem of complex structure. In addition, the use of waterproof adhesive not only leads to complex production process, but also may result in the problem of total volatile organic compounds (TVOC) exceeding the specified limits.

Therefore, there is still a need to continuously develop a new lightweight battery pack characterized by simple process, excellent mechanical strength and good waterproof performance in order to better meet the performance requirements for modern new energy vehicles.

### SUMMARY OF THE INVENTION

To address the above problems, the present invention aims to provide a battery case with simple structure, light weight, excellent mechanical strength and good waterproof effect, as well as a battery pack comprising the battery case.

The battery case according to the present invention comprises at least one resin-based composite material layer and at least one waterproof layer, and the resin-based composite material layer and the waterproof layer are bonded to each other by hot pressing.

In some embodiments, the battery case comprises at least two resin-based composite material layers and at least one waterproof layer, and the waterproof layer is arranged between the two resin-based composite material layers.

The present invention also provides a battery pack, which comprises a battery case as described above and a battery arranged inside the battery case.

### Beneficial Effects

The battery case of the present invention not only has remarkable lightweight effect, but also has excellent mechanical strength and good waterproof effect, as well as a simple structure.

### BRIEF DESCRIPTION OF THE DRAWINGS

To describe the embodiments of the present invention more clearly, the drawings required in the description of the embodiments will be briefly described hereinafter. Apparently, the drawings in the following description show merely some embodiments of the present invention, and a person of ordinary skill in the art may derive other embodiments from these drawings without creative efforts.

FIG. 1 is a structural diagram of the battery pack in the prior art.

FIG. 2 is a structural diagram of the battery case according to Example 1 of the present invention.

FIG. 3 is a structural diagram of the battery case according to Example 2 of the present invention.

FIG. 4 is a structural diagram showing the use of the battery case according to Example 1 of the present invention as the upper cover of the battery pack.

FIG. 5 is a structural diagram showing the use of the battery case according to Example 2 of the present invention as the upper cover of the battery pack.

FIG. 6 is a structural diagram showing the use of the battery case according to Example 2 of the present invention as both the upper cover and the lower cover of the battery pack.

In the figures, “1” refers to a resin-based composite material layer and “2” refers to a waterproof layer.

### DETAILED DESCRIPTION OF THE INVENTION

Hereinafter, the technical solutions in the embodiments of the present invention with reference to the accompanying drawings of the present invention will be clearly and completely described. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

In the description of the present invention, it should be understood that the terms “inner”, “outer”, “up”, “down” and the like indicate the orientation or position relationship based on the orientation or position relationship as illustrated in the drawings, and are merely for purposes of facilitating the description of the present invention, rather than indicating or implying that the members or elements referred to must have the specific orientations or are constructed in the specific orientations, and thus shall not be construed as limitations to the present invention. In the description of the present invention, unless otherwise stated, the “at least one layer” means one or more layers.

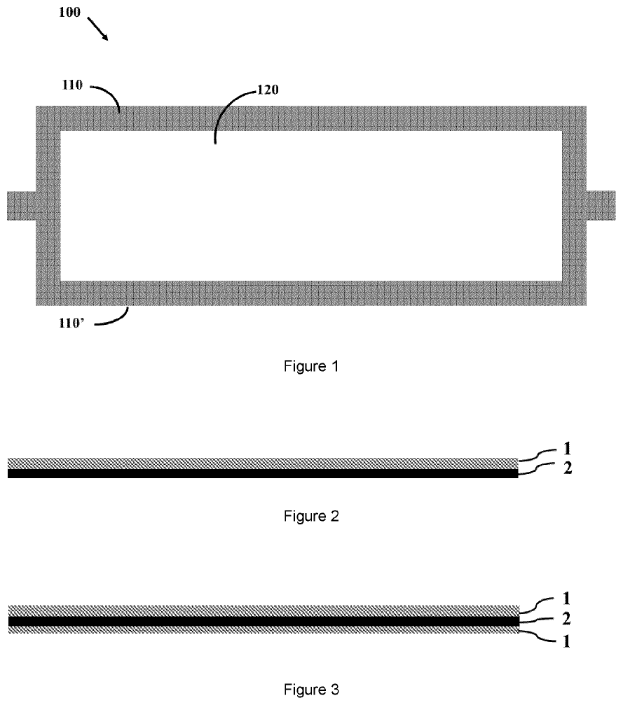

Referring to FIG. 1, it is a structural diagram of the battery pack 100 in the prior art comprising a battery case (110 and 110′); the battery case can be used as an upper cover 110 and a lower cover 110′ of the battery pack 100; and the upper cover 110 and the lower cover 110′ cooperate to form a space 120 for placing elements such as a battery or a battery module (not shown). In the present invention, the battery pack 100 includes but is not limited to the battery pack of new energy vehicles.

Nevertheless, as mentioned above, the current battery pack cases have the problems of being overweight, not waterproof and/or produced by complex processes.

To solve those problems, the present invention provides a battery case, which comprises at least one resin-based composite material layer and at least one waterproof layer, wherein the resin-based composite material layer and the waterproof layer are bonded to each other by hot pressing. The waterproof layer is arranged on the side of the resin-based composite material layer closer to or further away from the battery.

By using a resin-based composite material layer and a waterproof layer which are bonded through hot pressing, the battery case of the present invention not only achieves remarkable lightweight effect, but also has excellent mechanical strength, good waterproof effect, and a simple structure.

In the present invention, the resin-based composite material layer and the waterproof layer are bonded to each other by hot pressing to form an integrated structure. The hot pressing is perfomed by using the bonding property of the resin itself in the resin-based composite material for bonding, which requires no additional adhesive, and thus allows omission of applying an adhesive, thereby leading to a simple process.

In the present invention, the number of the resin-based composite material layer(s) and waterproof layer(s) is not specifically limited, and those skilled in the art can select an appropriate number of the layer(s) according to actual requirements. For example, in some embodiments, the number of the resin-based composite material layer(s) and waterproof layer(s) respectively is 1 to 4, such as 1, 2, 3 or 4. Preferably, the number of the resin-based composite material layer(s) is 1 to 3, such as 1, 2 or 3. Preferably, the number of the waterproof layer(s) is 1 to 3, such as 1, 2 or 3.

In a preferred embodiment of the present invention, the resin-based composite material layer and the waterproof layer are alternately arranged. The resin-based composite material layer and the waterproof layer arranged in this way enable the battery case to simultaneously have the advantages of excellent mechanical strength, good waterproof performance and lightweight.

In the present invention, when the word “alternately” is mentioned, it means that in the battery case, only a resin-based composite material layer is bonded to a waterproof layer, and only a waterproof layer is bonded to a resin-based composite material layer. Therefore, the use of the word “alternately” means that in the battery case of the present invention, there are not two waterproof layers bonded to each other, and there are not two resin-based composite material layers bonded to each other. In particular, when the battery case comprises only one resin-based composite material layer and one waterproof layer, the word “alternately” refers to the connection of one resin-based composite material layer and one waterproof layer.

In a preferred embodiment of the present invention, the waterproof layer is arranged on the side of the resin-based composite material layer closer to the battery. Therefore, the outermost layer of the battery case further away from the battery is a resin-based composite material layer. Accordingly, when the battery case is subjected to an external force, the resin-based composite material layer as the outermost layer can play a shock absorption role, thus avoiding damage to the waterproof layer and thereby an influence on the final waterproof effect. In addition, this arrangement can also prevent the wrinkles generated in the waterproof layer during the hot pressing process from being exposed to the outside of the battery case, thereby improving the appearance of the battery case member.

In one embodiment of the present invention, the battery case comprises at least two resin-based composite material layers and at least one waterproof layer, and the waterproof layer is arranged between the two resin-based composite material layers. Therefore, both the outermost layer further from the battery and the innermost layer closer to the battery of the battery case are resin-based composite material layers, an arrangement which can better protect the waterproof layer. At the same time, this arrangement can avoid the wrinkles generated in the waterproof layer during the hot pressing process from being exposed to the outside of the battery case, thereby improving the overall appearance of the battery case member. In addition, by arranging two layers of resin matrix composite material, the mechanical strength of the battery case can be further enhanced.

In one embodiment, the resin-based composite material layer is a resin-based porous material layer. The resin-based porous material is a material known in the art, which includes a porous material and a resin which is wrapped around the porous material. In the resin-based porous material, the resin is filled in the gaps or pores of the porous material, or the porous material is soaked in the resin.

In addition, the resin and porous material in the resin-based porous material are also known materials in the art.

In a preferred embodiment, the resin-based porous material layer has a porous structure. Preferably, the porous structure is derived from the cells generated by foaming of the resin in the resin-based porous material layer. The cell structure formed by foaming of resin is known to those skilled in the art. Therefore, in some embodiments, the resin-based porous material layer, especially its cross section, has a porous structure similar to cells.

In the present invention, the “cell” refers to the smallest structural unit that constitutes a single small cavity of foamed resin, and is formed by, among others, foaming agent, mechanical introduction of gas, or dissolution of soluble substances during foaming of the resin. The foaming includes, for example, physical foaming and chemical foaming. The physical foaming refers to foaming through gasification of physical foaming agent. The chemical foaming refers to foaming by generating gas (such as carbon dioxide) through the chemical reaction of chemical foaming agent such as water and isocyanate. The methods for forming cells are known to those skilled in the art.

In some embodiments, the resin in the resin-based porous material layer includes polyurethane or polyurea, epoxy resin or unsaturated resin; preferably, the resin is polyurethane resin. In some embodiments, the resin is a foamed resin, such as a foamed polyurethane resin. By using a foamed resin, the battery case can be further lightened. In some embodiments, the resin has a density of 100-1200 g/L, preferably 100-500 g/L.

In some embodiments, the porous material in the resin-based porous material layer has a single-layer surface density of 100 to 2400 g/m². In the present invention, the “single-layer surface density” refers to the mass per unit area in the porous material which forms one resin-based porous material layer. The methods for measuring the single-layer surface density are known to those skilled in the art.

As known in the art, the porous material is also called a reinforcement material. For example, the porous material includes fiber materials, such as glass fibers (GF), carbon fibers, natural fibers (such as bamboo fibers), especially natural fibers in the form of cloth, nonwoven cloth, and perforated (penetrated or non penetrated) flake-like materials, such as perforated metal plates wood plates and plastic plates, such as foamed aluminum and honeycomb panels. In a preferred embodiment, the porous material is a fiber reinforced material, in particular glass fibers (GF). Preferably, the porous material is a glass fiber material in the form of felt, such as glass fiber felt.

In some embodiments, the waterproof layer includes a metal sheet or a plastic sheet known in the art. Preferably, the metal sheet is selected from aluminum alloy, iron, steel and aluminum. Preferably, the plastic sheet is selected from at least one of the following materials: polyethylene (PE), polyvinyl chloride (PVC), polyethylene terephthalate (PET), polybutylene terephthalate (PBT), polypropylene (PP), thermoplastic polyurethane (TPU), polyurethane (PU), polyamide (PA), polyvinyl butyral (PVB) and ethylene-vinyl acetate copolymer (EVA). In a preferred embodiment, the plastic sheet is selected from polyurethane (PU), more preferably, thermoplastic polyurethane (TPU).

In the present invention, the waterproof layer has a thickness of 0.01-1 mm, preferably 0.02-0.3 mm. The thickness within the above ranges, on the one hand, ensures good adhesion between the layers when the resin-based composite layer and the waterproof layer are hot pressed into an integrated structure, and on the other hand, also ensures that the obtained battery case has excellent physical properties, especially waterproof performance.

The battery case of the present invention has a thickness of 1.0-50 mm, preferably 1.0-10 mm. In addition, and the battery case has an overall density of 0.5-2.7 g/cm³, preferably 1.1-1.8 g/cm³. Therefore, the battery case of the present invention has a remarkable lightweight effect. The “overall density” mentioned in the present description refers to the ratio of the total mass of the battery case itself to its total volume, as determined in accordance with GB/T 1033.1-2008.

The present invention also provides a battery pack, which comprises a battery case as described above and a battery inside the battery case.

In one embodiment of the present invention, the battery case is an upper cover and/or a lower cover of the battery pack. Preferably, the upper cover and lower cover of the battery pack are connected in a known way (such as by bolting) in the art. The upper cover and the lower cover cooperate to form a space for placing a battery.

In a preferred embodiment, the battery case has a shape adapted to the battery.

Hereinafter, the specific embodiments of the present invention will be illustrated by way of examples. However, it is understood that the present invention is not limited by these examples.

### Test Methods

Overall density: GB/T 1033.1-2008

Tensile strength: GB/T 1447-2005

Waterproof performance: GB 38031-2020

Preparation of battery cases

### Example 1

FIG. 2 illustrates the battery case according to Example 1 of the present invention. As shown in FIG. 2, the battery case had a two-layer structure. Specifically, it comprised a resin-based composite material layer 1 and a waterproof layer 2. The waterproof layer 2 was located on the side of the resin-based composite layer 1 closer to the battery (not shown).

The battery case of this embodiment was prepared by the following steps: step 1) first spraying polyurethane resin material to both sides (or one side) of the glass fiber felt through the nozzle: step 2) placing the waterproof layer made of thermoplastic polyurethane TPU into the mold, and placing the uncured resin-based glass fiber felt obtained in step 1) on the surface of the waterproof layer; and step 3) clamping the upper mold and the lower mold together and then curing by hot pressing to form an integrated piece.

In this embodiment, the waterproof layer 2 had a thickness of 0.05 mm, and the battery case had a thickness of 1.6 mm. The obtained battery case had an overall density of 1.5 g/cm³, and a tensile strength of 165 MPa. Therefore, the battery case of the present invention not only hadremarkable lightweight effect, but also had excellent mechanical strength.

### Example 2

FIG. 3 illustrates the battery case according to Example 2 of the present invention. As shown in FIG. 3, the battery case had a three-layer structure. Specifically, it comprised two resin-based composite material layers 1 and one waterproof layer 2. The waterproof layer 2 was located between the two resin-based composite layers 1. The two resin-based composite material layers 1 and the one waterproof layer 2 were bonded by hot pressing.

The battery case of this embodiment was prepared by the following steps: step 1) providing two layers of glass fiber felt; step 2) placing the waterproof layer made of thermoplastic polyurethane TPU between the two layers of glass fiber felt; step 3) spraying polyurethane resin material to the surfaces of the two layers of glass fiber felt respectively through the nozzle; and step 4) clamping the upper mold and the lower mold together and then curing by hot pressing to form an integrated piece.

In this embodiment, the waterproof layer 2 had a thickness of 0.05 mm, and the battery case had a thickness of 1.3 mm. The obtained battery case had an overall density of 1.7 g/cm³, and a tensile strength of 223 MPa. Therefore, the battery case of the present invention not only had remarkable lightweight effect, but also had excellent mechanical strength.

### Preparation of Battery Packs and Waterproof Test

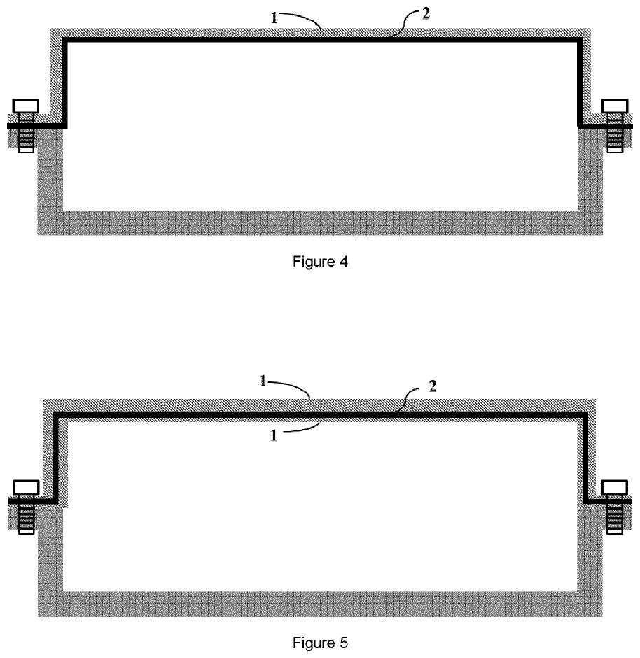

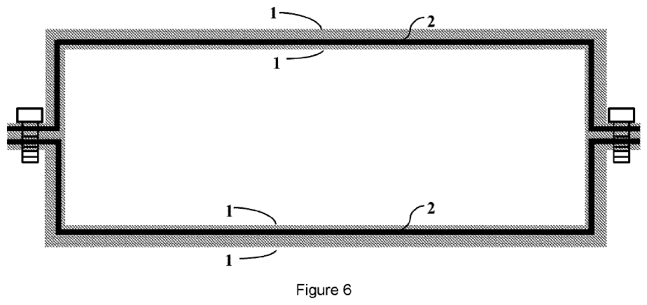

FIG. 4 illustrates the use of the battery case according to Example 1 of the present invention as the upper cover of the battery pack. FIG. 5 illustrates the use of the battery case according to Example 2 of the present invention as the upper cover of the battery pack. FIG. 6 illustrates the use of the battery case according to Example 2 of the present invention as both the upper cover and the lower cover of the battery pack. The upper cover and the lower cover of the battery pack were connected by bolts. The upper cover and the lower cover cooperated to form a space for placing a battery (not shown).

The aforementioned battery packs shown in FIGS. 4-6 were tested for waterproof performance in accordance with GB 38031-2020. The battery packs were placed in a water pool 3 with a water depth of 1.5 m for 30 minutes, and no bubbles were observed and no water leaked into the battery packs. During the following one hour, neither bubbles nor water leakage was observed.

It should be noted that although the waterproof layer 2 in the battery case shown in FIG. 4 above is arranged on the side of the resin-based composite layer 1 closer to the battery, those skilled in the art should understand that when the waterproof layer 2 is arranged on the side of the resin-based composite layer 1 further away from the battery, the battery case also has excellent waterproof performance.

The above results show that the battery cases of the present invention not only have remarkable lightweight effect, but also are characterized by excellent mechanical strength, excellent waterproof performance, and simple production process.

The basic principles and exemplary embodiments of the present invention are described above. It should be understood by one of ordinary skill in the art that the above descriptions are merely illustrative of the present invention and the present invention is not limited to the above-mentioned embodiments. Many changes and modifications may be made to the present invention without departing from the sprit and scope of the invention. All such changes and modifications are within the protection scope of the present invention.

1. A battery case comprising at least one resin-based composite material layer and at least one waterproof layer, wherein the at least one resin-based composite material layer and the at least one waterproof layer are bonded to each other by hot pressing.

2. The battery case according to claim 1, wherein a number of the at least one resin-based composite material layer and a number of the at least one waterproof layer is in each case 1 to 4.

3. The battery case according to claim 1, wherein the at least one resin-based composite material layer and the at least one waterproof layer are alternately arranged.

4. The battery case according to claim 1, wherein the at least one waterproof layer is arranged on a side of the at least one resin-based composite material layer that is closer to a battery of the battery case.

5. The battery case according to claim 1, wherein the battery case comprises at least two resin-based composite material layers and the at least one waterproof layer, and wherein the at least one waterproof layer is arranged between the at least two resin-based composite material layers.

6. The battery case according to claim 1, wherein the at least one resin-based composite material layer is a resin-based porous material layer that comprises a porous material and a resin wrapped around the porous material.

7. The battery case according to claim 6, wherein the resin-based porous material layer has a porous structure.

8. The battery case according to claim 6, wherein the resin is polyurethane, polyurea or epoxy resin, and wherein the porous material is glass fibers, carbon fibers, natural fibers or perforated metal plates, wood plates, or plastic plates.

9. The battery case according to claim 6, wherein the porous material has a single-layer surface density of 100 to 2400 g/m².

10. The battery case according to claim 1, wherein the at least one waterproof layer comprises a metal sheet or a plastic sheet.

11. The battery case according to claim 10, wherein the metal sheet is selected from the group consisting of aluminum alloy, iron, steel, and aluminum, and wherein the plastic sheet is selected from the group consisting of polyethylene PE, polyvinyl chloride PVC, polyethylene terephthalate PET, polybutylene terephthalate PBT, polypropylene PP, polyurethane PU, polyamide PA, polyvinyl butyral PVB, and ethylene-vinyl acetate copolymer EVA.

12. The battery case according to claim 10, wherein the plastic sheet is thermoplastic polyurethane TPU.

13. The battery case according to claim 1, wherein the at least one waterproof layer has a thickness of 0.01 mm to 1 mm.

14. The battery case according to claim 1, wherein the battery case has a thickness of 1.0 mm to 50 mm.

15. A battery pack comprising:
the battery case according to claim 1; and
a battery arranged inside the battery case.

16. The battery pack according to claim 15, wherein the battery case is an upper cover and/or a lower cover of the battery pack.
